(19) United States
(12) Patent Application Publication
(10) Pub. No.: US 2005/0101257 A1
(43) Pub. Date: May 12, 2005

(54) Wireless local area network test device

(75) Inventors: Florent Prat, Lyon (FR); Vincent Fargue, Lyon (FR)

Correspondence Address: BURR & BROWN, PO BOX 7068, SYRACUSE, NY, 13261-7068, US

(73) Assignee: 6LAN, Lyon (FR)

(21) Appl. No.: 10/995,680

(22) Filed: Nov. 23, 2004

Related U.S. Application Data
(63) Continuation of application No. PCT/FR03/01597, filed on May 27, 2003.

(30) Foreign Application Priority Data
May 30, 2002 (FR) 02.06617

(51) Int. Cl. H04B 17/00

(52) U.S. Cl. 455/67.11

(57) ABSTRACT

The invention relates to a test device (15) which permits the analysis of the connection quality at an access point to a wireless local access network, from a location which houses computer equipment, including a wireless communication card, characterised in being in the form of the body with a housing (9), for the interchangeable housing of a wireless communication card (16), means for processing emitted and/or received signals going to or coming from an access point to the network and means for displaying (17) information relating to said signals.

### TECHNICAL FIELD

The invention relates to the field of wireless computer networks. It relates more particularly to a test device that can be used to optimize or check the configuration of a wireless local area network, particularly relating to the hardware used, and the locations of the various points of access to the network. The invention can be used in particular to test microwave links complying with IEEE standards 802.11, HomeRF and HiperLAN.

### PRIOR ART

In the field of computer networks, there is considerable growth in wireless local area networks, also called WLANs. This type of network has great advantages over wired networks because of the flexibility of their interface which allows a user to move around within the zone covered by the network while remaining connected.

In general, the various items of computer equipment, such as the workstations, the printers or other peripherals are connected to the rest of the network by a microwave link.

This microwave link is used therefore to connect each item of equipment with a network access terminal, an item of equipment called an “access point” or “bridge”.

The various network access points are interconnected either by a microwave link or else by wired links.

The quality of the microwave link between an item of computer equipment and the corresponding access point is crucial for correct operation of the network and in particular for accessing the networked equipment at a sufficient bit rate. The quality of this microwave link depends in particular on the type of hardware employed and above all on the location of the access points and the locations intended to house the items of computer equipment.

This is why, when a wireless local area network is installed, it is necessary to carry out a certain number of checks in order to be sure of the quality of the connection to the various access points from locations likely to house the items of computer equipment.

To date, various methods or items of hardware are employed to carry out these checks.

Thus, in a first approach, it may be possible to estimate the quality of the connections from a theoretical modeling of the configuration of the premises, from the location of the various access points and from the type of hardware used. Software is used to assess the theoretical gains and bit rates corresponding to such a configuration.

It is very clearly conceivable that variations may be observed between the theoretical calculations and the real gains and bit rates such that this method relying uniquely on a theoretical evaluation is not truly satisfactory.

In a second approach, the quality of the connections may be checked by using a laptop computer which is fitted with a test program. This test program, for example that marketed by AVAYA under the reference “Orinoco Client Manager” is used to determine the value of the gain between a signal sent by an access point and the laptop computer which is fitted with a wireless communication card.

Such a solution is not really satisfactory since it cannot be used to truly analyze the correct operation of the network but simply to measure a gain. The network bit rate is in fact simply estimated from measured gain values, such that, when the network is truly under load, the real bit rate values very frequently differ from these theoretical bit rate values.

In addition, this method of verification requires, the use of a laptop computer which may be cumbersome. Also and above all, the measurements taken by this type of method are eminently dependent on the type of hardware used and in particular on the communication card associated with the laptop computer.

A third method is known for testing the quality of the connection which makes use of specific test devices such as in particular those marketed by Berkeley Varitronic System under the reference LOCUST. Such a device has the form of a unit which comprises a radio wave transmitter suitable for sending in the frequency range corresponding to the local area network. This device is used to view a certain number of information items relating to the quality of the connection and in particular the gain and the signal-to-noise ratio. This type of device has several disadvantages and in particular the fact that it cannot be used to load the network and check what is effectively the real bit rate that the network can support. In addition, the radio transmitter uses a proprietary communication program and the results obtained are consequently not representative of those obtained with the products finally installed because they also use another proprietary program. This type of transmitter therefore does not have the same features as on the communication cards associated with the various items of computer equipment intended to be connected to the network.

In other words, the analysis of the connection quality carried out by this type of device may diverge from the results of real performance observed with the items of equipment that will be connected to the network.

A first problem that the invention proposes to solve is that of allowing as complete an analysis as possible of the quality of the microwave link with the network access point, particularly by determining the bit rate values corresponding to network load situations.

Another problem which the invention proposes to solve is that of allowing an analysis of the connection quality that takes into account the type of hardware that will be used on the items of computer equipment intended to be linked to the network, with the great diversity that is known.

### SUMMARY OF THE INVENTION

The invention therefore relates to a test device used to analyze the quality of the connection to an access point of a wireless local area network from a location likely to house an item of computer equipment including a wireless communication card.

The test device according to the invention is characterized in that it has the form of a unit comprising:
a housing suitable for interchangeably receiving a wireless communication card;
means of processing signals sent to and/or received from the network access point;
means of displaying information relating to said signals.

In other words, the device according to the invention may receive different communication cards which are advantageously chosen to have the properties analogous to those that are mounted on the items of equipment intended to be installed in the test location.

Thus, advantageously in practice, the housing of the device may be configured to receive wireless communication cards of the PCMCIA (Personal Computer Memory Card International Association) type.

If the items of computer equipment intended to be connected to the network are laptop computers fitted with a housing for receiving a PCMCIA card, the communication card mounted in the test device may be an identical card, or a card whose sending portion has identical or equivalent properties and features. Thus the user may insert into the device a PCMCIA card that has the same manufacturer and reference as those finally used on the site tested.

Naturally, items of computer hardware other than laptop computers may receive communication cards in PCMCIA format.

If the items of computer equipment intended to be installed on the network have communication cards of a different format, the choice of PCMCIA card to be inserted in the test device will be a card whose transmit/receive portion strictly speaking has the same features and properties.

By this disposition, the results of the analysis of the connection quality will be highly representative of the actual situation when the items of computer hardware are connected to the network.

Advantageously in practice, the processing means associated with the test device are suitable for controlling the operation of the associated communication card, according to a program or driver, selected from a predetermined list.

In other words, the test device contains the various configuration files or drivers that can be used to operate the communication card.

These files are advantageously identical to those that will be installed in the items of computer equipment, so as to obtain an analysis result corresponding as closely as possible to the reality of the network.

Advantageously in practice, the test device also comprises means of updating the predetermined list of drivers in order to be able to use the latest driver versions, or more generally versions corresponding to those that are installed in the items of computer equipment intended to be connected to the network.

According to another feature of the invention, the test device also comprises means of recording, items of information relating to the signals sent to and/or received from the network access point so that a certain number of statistics concerning this connection can be established.

Advantageously in practice, the test device may also comprise means of transferring to a computer the various items of information relating to the signals interchanged with the network access point.

In this way, it is possible to carry out further improved processes and/or test data backups on a separate computer.

According to another feature of the invention, the test device is programmed in such a way that the processing means are suitable for sending data packets or frames according to a protocol compatible with the wireless local area network.

In this way, the transmission of these frames can be used to check the operation of the network when it is under load which means that the changes in the bit rate can be analyzed as a function of this load.

Advantageously in practice, the processing means are suitable for sending frames of different length and for determining the change in the bit rate as a function of the type of frame sent.

Advantageously in practice, a length of the frames can be configured by the user so that he can carry out various types of tests corresponding to different situations of network use.

Similarly, the frame sending tasks may be programmed to be carried out repetitively and for predetermined periods corresponding to other types of network use.

### BRIEF DESCRIPTION OF THE FIGURES

The manner in which the invention is achieved and the advantages arising therefrom will clearly emerge from the description of the embodiment that follows, given as a nonlimiting example, and in support of the appended figures in which:

FIG. 1 is a schematic view illustrating a portion of a wireless local area network.

FIG. 2 is a summary view in perspective of the test device according to the invention.

### MANNER IN WHICH THE INVENTION IS ACHIEVED

As already evoked, the invention concerns a test device intended to analyze the quality of the microwave links for connection to a wireless local area network.

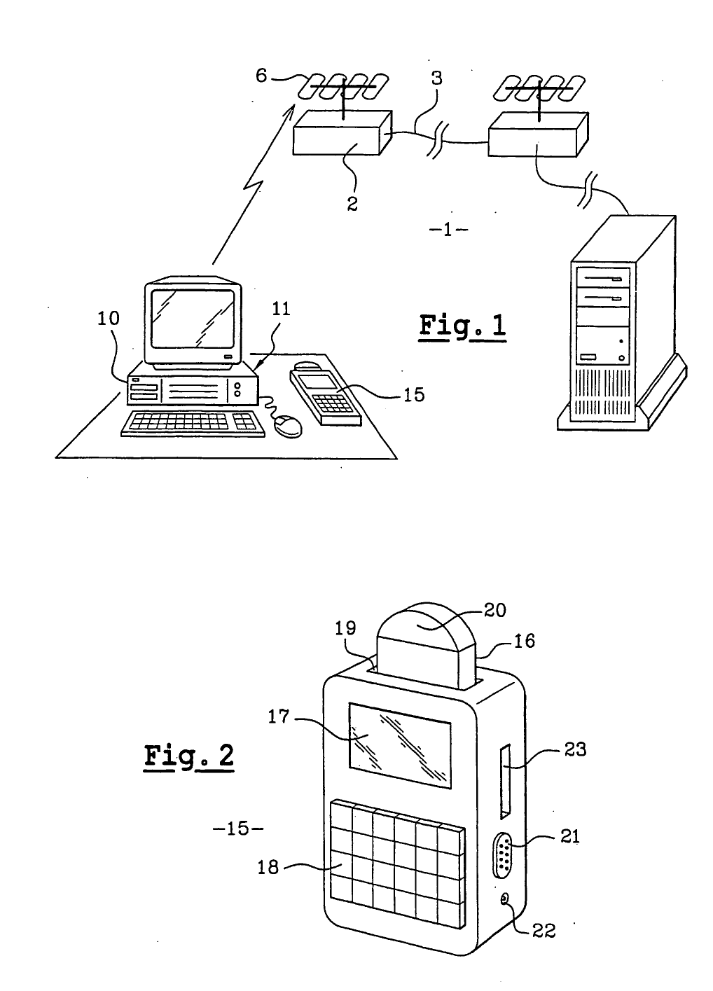

In the configuration illustrated in FIG. 1, the local area network (1) is represented by a certain number of bridges (2) interconnected by wired links (3), and also connected for example to a server (4). Naturally, this is a schematic representation and the invention is used to analyze the properties of types of wireless networks with extremely varied architectures that may be particularly complex.

More precisely, each bridge (2) constitutes a point of access to the network and is fitted with transmission and reception means including in particular an antenna (6).

These bridges (2) are placed in appropriate locations on the premises in which the network is deployed. This bridge or these bridges may be the items of equipment that exist on the market and are intended to be physically installed in the network during deployment. In certain cases, the network access points may be simulated by particular items of equipment, commonly called “beacons” employed only during the installation phase. These “beacons” are items of equipment playing the role of bridges, but with limited performance. They therefore have the same components performing the communication functions as the bridges that they simulate.

The objective of the invention is to make it possible to determine the quality of the microwave link between a bridge (2) forming a network access point and an item of computer equipment (10) placed in a determined location.

In the form illustrated, this item of equipment is represented as a computer (10) in which is installed a wireless communication card (11).

This card (11) may be of the plug-in and pull-out type according to the PCMCIA standard. It may more commonly be an extension card of the PCI type (called cradle card) permanently mounted in the central unit of the computer (10) and supporting a PCMCIA card.

It may further be a wireless communication module connected by another means to the central processor unit, for example via a link of the USB type.

Naturally, other items of computer equipment may be connected to the wireless network such as printers, barcode readers, personal organizers (PDA type), mobile telephones, etc.

The items of computer equipment may also be simulated by “beacons” as previously mentioned, particularly during the network deployment phases, before the final hardware is installed. In this case, each beacon comprises a wireless communication card allowing it to be connected to the network via the bridge (2) or a bridge with limited performance, formed by a beacon. In this way, a network comprising several items of connected computer equipment may be simulated realistically even before the final installation.

The invention therefore concerns a test device (15) as illustrated in FIG. 2 which can be used to analyze the quality of the microwave link with the wireless network.

This portable device (15) may be moved within the zone of reach of the bridge (2). It may in particular be placed in the future locations of the various items of equipment that will be intended to be connected to the network (1).

In accordance with the invention, this test device (15) has the form of a unit which comprises a microcontroller intended to perform a data processing function, a microwave link card and an interface (17, 18) used to display the computed data and to enter the instructions. This microcontroller allows a rapid start-up and rapid shut-down of the unit. The unit may operate equally well when connected directly to the mains supply via an integral power supply input (22) or with rechargeable batteries, where appropriate via the input (22) or not.

More precisely, the microcontroller can be mounted on a card, for example in PC 104, or ETX/ENCORE format or on a card developed specifically for the application. This card is associated with an additional card compatible with the microcontroller card and arranged to receive a microwave communication card of the PCMCIA type (16).

In a particular form, this additional card (16) may receive several cards of the PCMCIA type, one of which serves as the microwave link, the other being capable of being used for secondary functions such as in particular data backup.

An important feature of the invention lies in the ability to interchange the microwave communication card (16) to use a card identical or analogous to that which is fitted in the items of computer equipment intended to be connected to the network.

As already mentioned, these may be identical cards if these items of equipment are fitted with cards of the PCMCIA type. Similarly, when the cards installed in the computers for example are cards of the PCI type, the PCMCIA card (16) chosen to be inserted into the test unit will be the same as the PCMCIA card inserted in the PCI cradle card. In the context, for example, of a PSB unit incorporating a transmit/receive module, the PCMCIA card (16) chosen to be inserted in the test unit will be a card whose transmit/receive module (20) is similar, that is to say has properties and features identical or extremely similar to the one (11) mounted in the computer (if possible of the same manufacturer).

The similarity between the two communication cards lies also in the use of configuration files, or drivers, which are also identical or analogous.

Specifically, the test unit (15) performs the function of the communication card and the interchange of information according to a driver that is dedicated to the card and that may advantageously be the same as that which will be installed in the item of computer equipment connected with the network.

This possibility can be used to test the quality of the microwave link in software and hardware conditions particularly close to those which will prevail when the final computer hardware (10) is connected to the network.

To do this, the unit (15) comprises memory means, including a set of drivers corresponding to each of the communication cards which may be inserted into the unit. This driver may be loaded automatically according to the type of card inserted in the unit, or yet be chosen precisely and on request by the user by access via a menu.

These drivers may also be downloaded into the unit either via a wired link connected for example by a serial link to the unit or via any other type of link, particularly parallel or USB.

Naturally, the downloading may also be carried out by the microwave link via the communication card (16) or via an integral memory card reader (23) of the COMPACTFLASH type. The unit may incorporate communication functionalities according to a TFTP protocol allowing in particular dialog with the beacons simulating the items of computer equipment of the network or the limited performance bridge.

In operation, the processing means including the unit can be used to compute and display various magnitudes relative to the operation of the network. Amongst these magnitudes can in particular be mentioned the signal level received both from the bridge (2) and the card (11) and the noise level, and therefore the signal-to-noise ratio. The quality of the link may also be characterized by the bit rate of the link and the gain. These parameters will therefore be analyzed and may be saved bidirectionally, that is both at the bridge (2) and at the card (11).

Other parameters relating to the link may be processed by the unit (15) and in particular the parameters for identifying the network and the bridge used and the communication channel in use.

The fact that the link is encrypted or not may also be determined by the processing means.

According to another feature of the invention, the unit (15) is configured to send to the bridge sets of data, also called frames, to verify the correct operation of the network under load.

These frames may for example be configured according to the IP (Internet Protocol) protocol, and include conventionally items of information relating to the address of the sender, the address of the receiver, the type of data transmitted, and verification codes of CRC type.

The processing means are suitable for sending frames of different lengths, corresponding to different states of network load, these lengths being able to go from a few hundred to a few thousand bytes.

Various methods of operation may be used corresponding to different tests.

Frame sequences of identical or variable lengths may be sent either at intervals or continuously in order to verify that they are correctly transmitted to the bridge by analyzing the acknowledgement frame sent by the bridge. Adjustments to the duration of the test and the length of the frames may be made by the user.

To do this, the user has a keypad (18) at his disposal on the unit. This keypad may comprise various keys as in the form illustrated in FIG. 2 or may even include fewer keys that can be used to browse through menus appearing on the screen (17) of the LCD type for example. The keypad may also include levers (or joysticks) or yet devices of the built-in tactile mouse type or tactile screen zones.

The processing means are configured to allow the transmission power and the frequency to be modified in the range accessible by the communication card.

The processing means are also configured to allow bit rates corresponding to the standard IEEE 802.11. These bit rates may adopt values of 1, 2, 5.5 and 11 megabits/second but the processing means are configured for adaptation to different bit rates if necessary, for example the values of 54, 36, 24, 12 and 6 megabits/second for the standard 802.a.

The processing means are configured to display a certain number of information items on the screen (17) installed on the unit.

The list of information items displayed corresponds to that mentioned hereinabove. This list may, where necessary, be configured according to the requirements of the user and as the standards and drivers associated with the cards change.

The data relating to the various links and to the various test operations under load may be backed up in the unit or yet be transmitted either via a wired link or via a microwave link to a remote computer that can be used to produce statistics but again carries out backups or other iterative analyses.

These backups may, for example, be made by using a memory card reader/burner of the COMPACTFLASH type integral with the unit (23).

Naturally, the link of the unit (15) with any item of computer equipment can be used for downloading both the most recent version of the program intended to run the processing means and the various updates of drivers of the communication cards likely to be installed in the test device.

As a result of the foregoing, the test device according to the invention has many advantages, and in particular:
a possibility of receiving communication cards corresponding in their hardware and software portion to those that will be employed in the hardware items later connected to the wireless network;
the possibility of carrying out tests of bit rate and of gain under load, by sending different types of frame of variable length;
the possibility of recording and personalizing the tests carried out;
the possibility of downloading programs or drivers for updating the programs within the unit;
the possibility of starting up and shutting down quickly.

1. A test device (15) used to analyze the quality of the connection to an access point (1) of a wireless local area network, from a place likely to house an item of computer equipment (10) including a wireless communication card (11), characterized in that it has the form of a unit comprising:
a housing (9) suitable for interchangeably receiving a wireless communication card (16);
means of processing signals sent to and/or received from the network (1) access point (2);
means of displaying (17) information relating to said signals.

2. The test device as claimed in claim 1, characterized in that the housing (19) is suitable for receiving wireless communication cards (16) of the PCMCIA type.

3. The test device as claimed in claim 1, characterized in that the processing means are suitable for controlling the operation of the wireless communication card, according to a program or driver, selected from a predetermined list.

4. The test device as claimed in claim 3, characterized in that it comprises means of updating the predetermined list of drivers.

5. The test device as claimed in claim 1, characterized in that it comprises information and recording means relating to the signals sent to and/or received from the network access point (2).

6. The test device as claimed in claim 1, characterized in that it comprises means of transferring (21) to the computer information relating to the signals sent to and/or received from the network access point.

7. The test device as claimed in claim 1, characterized in that the processing means are suitable for sending data packets or frames according to a protocol compatible with the wireless local area network.

8. The test device as claimed in claim 7, characterized in that the processing means are suitable for sending frames of different lengths.

9. The test device as claimed in claim 8, characterized in that the length of the frames can be configured by the user.

10. The test device as claimed in claim 9, characterized in that the frame transmission time can be configured by the user.

11. An assembly comprising a test device as claimed in claim 1 and at least one item of equipment suitable for receiving and sending signals sent to and received from said device, and playing the role of network access point.

12. The assembly comprising a test device as claimed in claim 1 and at least one item of equipment suitable for receiving and sending signals sent to and received from the network (1) access point (2), said item of equipment playing the role of an item of computer hardware connected to the network.
